(19) United States
(12) Patent Application Publication
(10) Pub. No.: US 2008/0155173 A1
(43) Pub. Date: Jun. 26, 2008

(54) Data processing apparatus

(75) Inventors: Ken Hatano, Tokyo (JP); Terunobu Hara, Tokyo (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/804,620

(22) Filed: May 18, 2007

(30) Foreign Application Priority Data
Dec. 26, 2006 (JP) P2006-350398

(51) Int. Cl. G06F 12/00

(52) U.S. Cl. 711/102; 711/E12.001

(57) ABSTRACT

According to one embodiment, a data processing apparatus includes a disk drive having a non-volatile memory and a disk storage medium, a setting unit for setting priority to each of a plurality of memory storage data to be stored in the non-volatile memory, and a control unit for storing in the non-volatile memory at least one data among the plurality of memory storage data according to the priority set by the setting unit.

### CROSS-REFERENCE TO RELATED APPLICATIONS

This application is based upon and claims the benefit of priority from Japanese Patent Application No. 2006-350398, filed Dec. 26, 2006, the entire contents of which are incorporated herein by reference.

### BACKGROUND

1. Field

One embodiment of the invention relates to a data processing apparatus including an external storage device such as HDD.

2. Description of the Related Art

Conventionally, there are known data processing apparatuses including a hard disk drive (HDD), a non-volatile memory for storing various types of data such as operating time of the HDD, accumulated values of the number of power outages occurred and the number of vibrations received during operation of the HDD, and a diagnosis circuit for diagnosing the possibility of failure of the HDD based on data stored in the non-volatile memory (see, for example, Japanese Patent Application Publication (Kokai) No. 2005-267799).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing an appearance of a data processing apparatus according to an embodiment of the invention;

FIG. 2 is an exemplary block diagram showing a system configuration of the data processing apparatus in the embodiment;

FIG. 3 is an exemplary table showing an example of information stored in a non-volatile memory included in a south bridge in the embodiment;

FIG. 4 is an exemplary block diagram showing a configuration example of a disk drive provided in the data processing apparatus in the embodiment;

FIG. 5 is an exemplary view showing an overview of switching of data from a hard disk to a non-volatile memory in the embodiment;

FIG. 6 is an exemplary block diagram showing a functional configuration of BIOS used in the data processing apparatus in the embodiment;

FIG. 7 is an exemplary view showing an example of a setup screen displayed by the BIOS in the embodiment;

FIG. 8 is an exemplary flowchart showing a procedure of command generation processing executed by the data processing apparatus in the embodiment; and

FIG. 9 is an exemplary flowchart showing a processing procedure of HDD when a command is received in the embodiment.

### DETAILED DESCRIPTION

Various embodiments according to the invention will be described hereinafter with reference to the accompanying drawings. In general, according to one embodiment of the invention, a data processing apparatus includes a disk drive having a non-volatile memory and a disk storage medium, a setting unit for setting priority to each of a plurality of memory storage data to be stored in the non-volatile memory, and a control unit for storing in the non-volatile memory at least one data among the plurality of memory storage data according to the priority set by the setting unit.

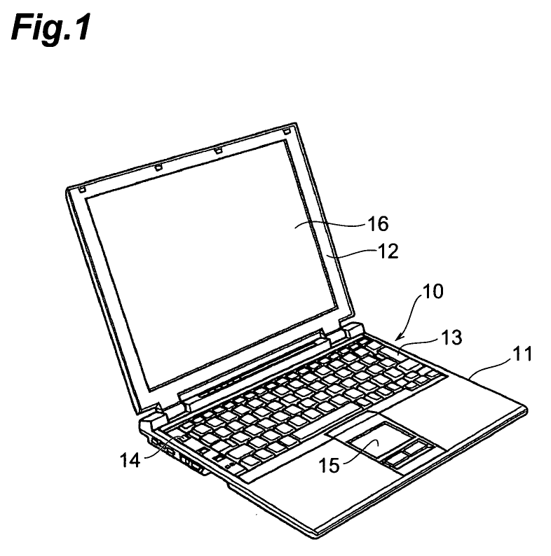

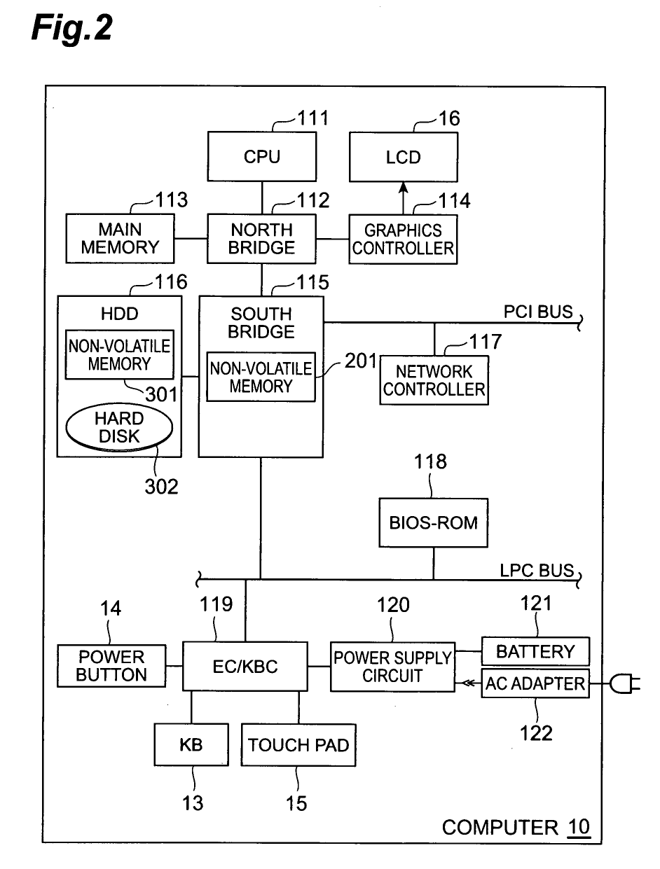

First of all, with reference to FIG. 1 and FIG. 2, a configuration of a data processing apparatus according to this embodiment will be explained. FIG. 1 is an exemplary perspective view showing an appearance of the data processing apparatus in this embodiment. FIG. 2 is an exemplary block diagram showing a system configuration of the data processing apparatus in this embodiment. In this embodiment, a notebook type computer 10 that can be driven by a battery is used as an example for explaining the data processing apparatus.

The computer 10 includes, as shown in FIG. 1, a computer body 11 and a display unit 12.

The computer body 11 has a case in a thin box shape. On an upper surface of the computer body 11, a keyboard 13, a power button 14 for turning on/off the power of the computer 10, and a touch pad 15 are arranged.

In the display unit 12, an LCD (Liquid Crystal Display) 16 is incorporated as a display device. A display screen of the LCD 16 is located substantially at the center of the display unit 12. The display unit 12 is supported on the computer body 11, and is attached to be capable of turning relative to the computer body 11 between an open position to expose the upper surface of the computer body 11 and a close position to cover the upper surface of the computer body 11.

The computer 10 internally includes, as shown in FIG. 2, a CPU 111, a north bridge 112, a main memory 113, a graphics controller 114, a south bridge 115, a hard disk drive (HDD) 116, a network controller 117, a BIOS-ROM 118, an embedded controller/keyboard controller IC (EC/KBC) 119, a power supply circuit 120, a battery 121 and an AC adapter 122.

The CPU 111 is a processor for controlling operations of respective components of the computer 10. The CPU 111 executes an operating system and various types of application programs, which are loaded from the HDD 116 to the main memory 113. The CPU 111 also executes BIOS (Basic Input Output System) stored in the flash BIOS-ROM 118. The BIOS is a program (firmware) for controlling the basic operation of the computer 10. The BIOS is executed first when the power of the computer 10 is turned on, and executes POST (Power-On Self Test) processing for initializing the respective components.

The north bridge 112 is a bridge device for connecting a local bus of the CPU 111 and the south bridge 115. The north bridge 112 has a function to execute communication with the graphics controller 114 via an AGP (Accelerated Graphics Port) bus or the like. The north bridge 112 internally includes a memory controller for controlling the main memory 113.

The graphics controller 114 is a display controller for controlling the LCD 16 which is used as a display monitor for the computer 10. The south bridge 115 is connected to a PCI (Peripheral Component Interconnect) bus and to an LPC (Low Pin Count) bus respectively. The south bridge 115 internally includes a non-volatile memory 201.

The HDD 116 is a so-called hybrid disk drive, which includes a non-volatile memory 301 and a hard disk 302 as storage media. The non-volatile memory 301 is constituted of, for example, a NAND-type flash EEPROM. The hard disk 302 is a disk storage medium for recording data magnetically. Writing data to and reading data from the hard disk (disk storage medium) 302 are executed using a mechanical driving mechanism provided in the HDD 116. This driving mechanism includes a spindle motor for rotating the hard disk 302, a head for writing and reading data, an actuator for moving the head, and so forth.

When data (user file, system file, or the like) specified by a read request from the CPU 111 exists in the non-volatile memory 301, access to the hard disk 302 is not executed, and corresponding data is read from the non-volatile memory 301. Therefore, the HDD 116 is capable of quickly reading necessary data from the non-volatile memory 301 without rotating the hard disk 302.

The embedded controller/keyboard controller IC (EC/KBC) 119 is a one-chip microcomputer in which an embedded controller for managing power supply and a keyboard controller for controlling the keyboard (KB) 13, the touch pad 15 and so on are integrated. The EC/KBC 119 cooperates with the power supply circuit 120 to turn on/off the power of the computer 10 according to an operation of the power button switch 14 by the user. The power supply circuit 120 uses external power supply that is supplied from the battery 121 or the AC adapter 122 internally included in the computer body 11 so as to generate system power supply to be supplied to the respective components of the computer 10.

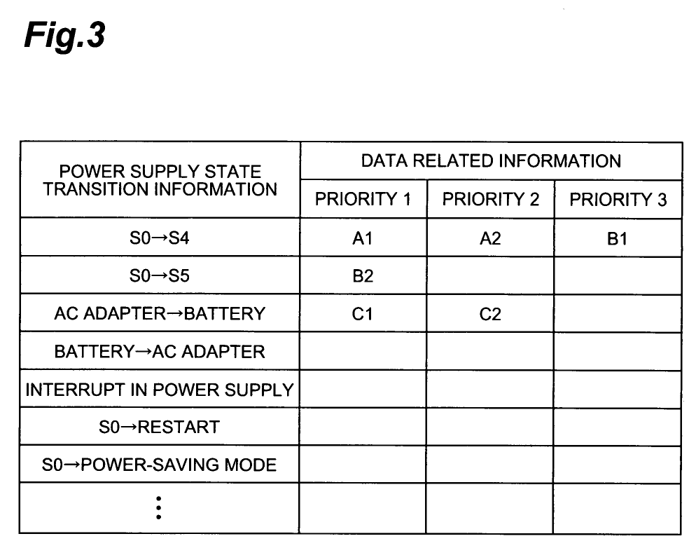

Now, with reference to FIG. 3, data stored in the non-volatile memory 201 will be described. FIG. 3 is an exemplary table showing an example of information stored in the non-volatile memory provided in the south bridge in this embodiment.

In addition to set-up information indicating the operation environment of the computer 10, the non-volatile memory 201 stores, as shown in FIG. 3, power supply state transition information and at least one (up to three in this embodiment) pieces of data related information in a correlated manner. In this embodiment, correlation of the power supply state transition information and the data related information can be arbitrarily set by the user according to his/her preference (this will be described in more detail later).

The power supply state transition information is information indicating a transition of power supply state of the computer 10. Specifically, in FIG. 3, the power supply state transition information is denoted as “S0→S4”, “S0→S5”, “AC adapter→battery”, “battery→AC adapter”, “interrupt in power supply”, “S0→restart”, “S0→power-saving mode”, and so on. Here, “S0→S4” denotes that the power supply state changes in state from S0 to S4. “S0→S5” denotes that the power supply state changes in state from S0 to S5. “AC adapter→battery” denotes that the external power supply state changes from the AC adapter 122 to the battery 121. “Battery→AC adapter” denotes that the power supply state (supply source of external power supply) changes from the battery 121 to the AC adapter 122. “Interrupt in power supply” denotes that a predetermined power supply state changes to a state that the external power supply is interrupted. “S0→restart” denotes that the power supply state changes from the S0 state to a restart state. “S0→power-saving mode” denotes that the power supply state changes from the S0 state to a power-saving mode state.

Incidentally, “S0”, “S4”, “S5” are system states specified respectively in the ACPI (Advanced Configuration and Power Interface) specification, which is one of power management techniques. The ACPI specification defines “S0” as operation state (a state that the power of the system is on and software is running), “S4” as non-operation state (also called hibernation, a state that the power of the CPU 11 and a chip set thereof is off, and the contents of the main memory 113 are stored in the hard disk 302), and “S5” as off-state (a state that execution of software is finished and the power of the system is off), respectively.

The data related information is information related to data to be stored in the non-volatile memory 301 when there is a transition of a power supply state indicated by corresponding power supply state transition information. In this embodiment, to one piece of power supply state transition information, up to three pieces of data related information can be correlated in a state that priority (priority 1 to 3) is assigned. Specifically, in FIG. 3, three pieces of data related information, “A1” (priority 1), “A2” (priority 2) and “B1” (priority 3) are correlated to “S0→S4” one piece of data related information “B2” (priority 1) is correlated to “S0→S5” (priority 1), and two pieces of data related information, “C1” (priority 1) and “C2” (priority 2) are correlated to “AC adapter→battery”. The data related information “A1”, “A2, “B1”, “B2”, “C1”, “C2” in FIG. 3 are information related to data A1, A2, B1, B2, C1, C2, and are information to specify data A1, A2, B1, B2, C1, C2 respectively.

Here, in data A1, A2, B1, B2, C1, C2, “A”, “B”, “C” denote the type of data respectively. Thus, the data A1 (B1, C1) and the data A2 (B2, C2) denote that the types of data are the same “A (B, C)”, but the contents thereof are different. The data type “A” is, for example, a password or the like of a device which needs authorization when the computer 10 is started up, such as a fingerprint device or a smart card device connected to or internally included in the computer 10 (hereinafter referred to as startup time authorization data). The data type “B” is, for example, a password or the like which is used for authorization when a mail is sent or received (hereinafter, referred to as mail authorization data). The data type “C” is various types of diagnosis data obtained by execution of a self-diagnosis function called SMART (Self-Monitoring Analysis and Reporting Technology) included in the HDD 116 (hereinafter referred to as SMART DATA).

The SMART data is information indicating the condition of the HDD 116, particularly the condition of the hard disk 302, and indicates a value corresponding to each of a large number of test items. The test items include, for example, “Raw Read Error Rate” (error occurrence rate when reading data from the hard disk 302), “Reallocated Sectors Count” (the number of sectors to which replacement processing is performed due to sector failure), “Spin up Time” (a time required from start of rotation of the hard disk 302 until the rotation speed of the hard disk 302 reaches a regular rotation speed), “Temperature” (temperature in the HDD 116), and so on. Note that a large number of data exist as data to be stored in the non-volatile memory 301 when there is a transition of power supply state indicated by the power supply state transition information besides the above-described startup time authorization data of the type “A”, mail authorization data of the type “B”, SMART data of the type “C”, an explanation is given below by focusing on these three types of data.

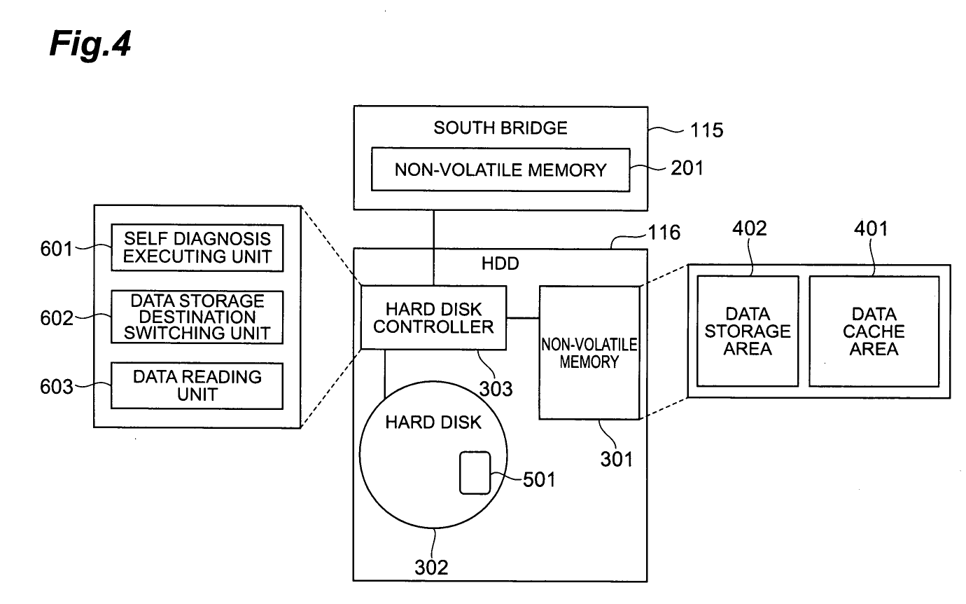

Next, with reference to FIG. 4, a configuration example of the HDD 116 will be explained. FIG. 4 is an exemplary block diagram showing a configuration example of a disk drive provided in the data processing apparatus in this embodiment.

The HDD 116 includes a hard disk controller 303 in addition to the above-described non-volatile memory 301 and the hard disk 302. The hard disk controller 303 is a controller for accessing each of the non-volatile memory 301 and the hard disk 302. This hard disk controller 303 can selectively access the non-volatile memory 301 and the hard disk 302 according to an access request transmitted from the CPU 111 via for example an ATA (At Attachment) controller provided in the south bridge 115.

In the storage area of the non-volatile memory 301, a data cache area 401 and a data storage area 402 are defined.

The data cache area 401 is a storage area for temporarily storing data read from the hard disk 302 and data to be written to the hard disk 302. When a read request is received from the CPU 111, the hard disk controller 303 judges whether data specified by the read request from the CPU 111 exists or not in the data cache area 401. If the data specified by the read request exists in the data cache area 401, the hard disk controller 303 reads the data specified by the read request from the data cache area 401. The hard disk controller 303 maintains the hard disk 302 in a rotation halt state during a period in which it is not necessary to access the hard disk 302. On the other hand, only when it is necessary to access the hard disk 302, the hard disk controller 303 spins up the hard disk 302 to execute the access to the hard disk 302, and stops rotation of the hard disk 302 after the access to the hard disk 302 is completed.

The data storage area 402 is a storage area for storing the startup time authorization data, the mail authorization data, the SMART data, and so on. Also in the storage area of the hard disk 302, there is defined a data storage area 501 as a storage area for storing the startup time authorization data, the mail authorization data, the SMART data, and so on.

The hard disk controller 303 includes a self diagnosis function executing unit 601, a data storage destination switching unit 602 and a data reading unit 603.

The self diagnosis function executing unit 601 is a unit for executing a self diagnosis function of the above-described HDD 116. The self diagnosis executing function is executed for example during execution of access to the hard disk 302. Of course, the self diagnosis function may be configured to be executed regularly according to a predetermined schedule.

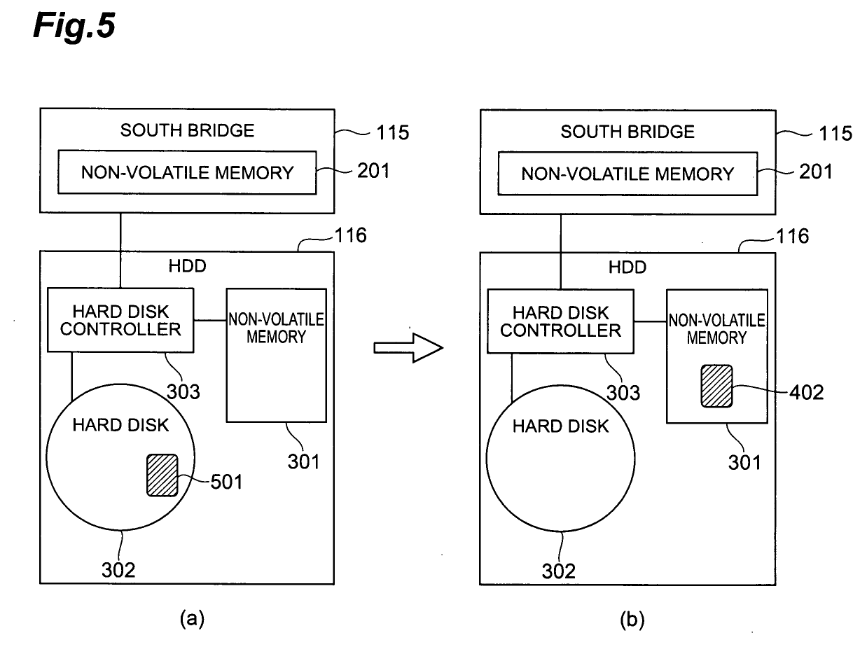

The data storage destination switching unit 602 is a unit for switching a medium in which the startup time authorization data, the mail authorization data, the SMART data, and so on are to be stored between the non-volatile memory 301 and the hard disk 302. In other words, the data storage destination switching unit 602 has a function to switch, as shown in FIG. 5, the storage destination of data (storage instructed data) for which there is a storage instruction (described in detail later) by a storage command generated by a command generating unit 703 among the startup time authorization data, the mail authorization data, the SMART data, and so on from the hard disk 302 to the non-volatile memory 301.

In response to a read request of the startup time authorization data, the mail authorization data, the SMART data, and so on from the CPU 111, the data reading unit 603 judges that which of the non-volatile memory 301 and the hard disk 302 stores data (read requested data) for which there is a read request among the startup time authorization data, the mail authorization data, the SMART data, and so on. When the read requested data is stored in the non-volatile memory 301, the data reading unit 603 reads the read requested data from the non-volatile memory 301 for sending the read requested data to the CPU 111. On the other hand, when the read requested data is stored in the hard disk 302, the data reading unit 603 reads the read requested data from the hard disk 302 for sending the read requested data to the CPU 111.

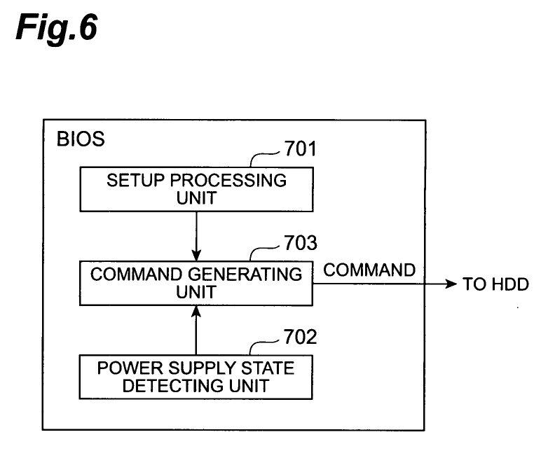

Next, with reference to FIG. 6, a functional configuration of BIOS will be explained. FIG. 6 is an exemplary block diagram showing a functional configuration of BIOS used in the data processing apparatus in this embodiment.

The function to store the startup time authorization data, the mail authorization data, the SMART data, and so on in the non-volatile memory 301 when there is a transition of power supply state can be realized by the BIOS. The BIOS includes a setup processing unit 701, a power supply state detecting unit 702 and a command generating unit 703 as functional configuration modules thereof. These setup processing unit 701, power supply state detecting unit 702 and command generating unit 703 are software modules executed by the CPU 111.

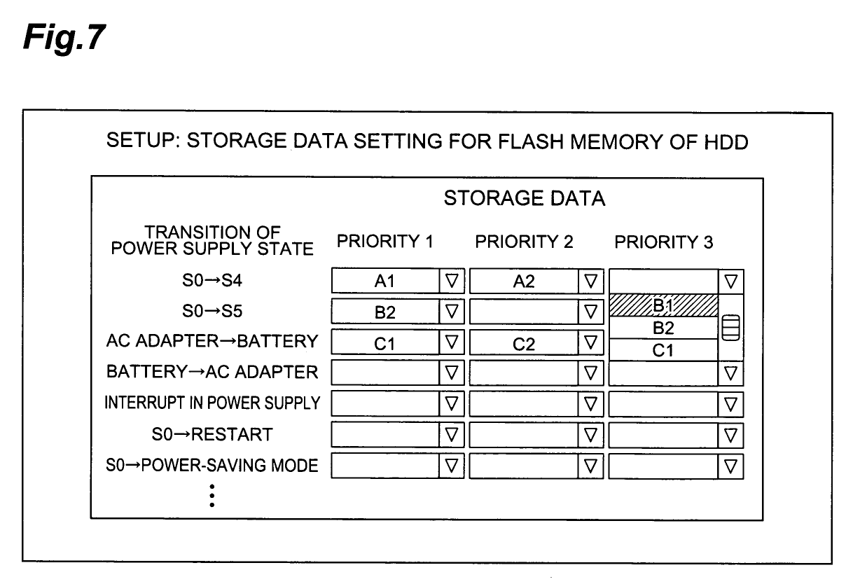

The setup processing unit 701 displays on the LCD 16 a setup screen for allowing the user to specify the operating environment of the computer 10. As shown in FIG. 7, this setup screen allows the user to select, together with priority, storage data (the startup time authorization data, the mail authorization data, the SMART data, and so on) desired by the user to be stored in the non-volatile memory 301 when there is a transition of power supply state. When setting of the storage data is performed by the user, the setup processing unit 701 correlates information (power supply state transition information) indicating transition of power supply state and information regarding storage data selected corresponding to the transition of power supply state, and stores them together with other information specifying the operating environment in the non-volatile memory 201 in the south bridge 115.

The power supply state detecting unit 702 detects the power supply state of the computer 10 constantly (or at predetermined intervals). The power supply state detecting unit 702 compares a previously detected power supply state and a currently detected power supply state, and when they are different, it judges that there is a transition of power supply state and sends the judgment result to the command generating unit 703.

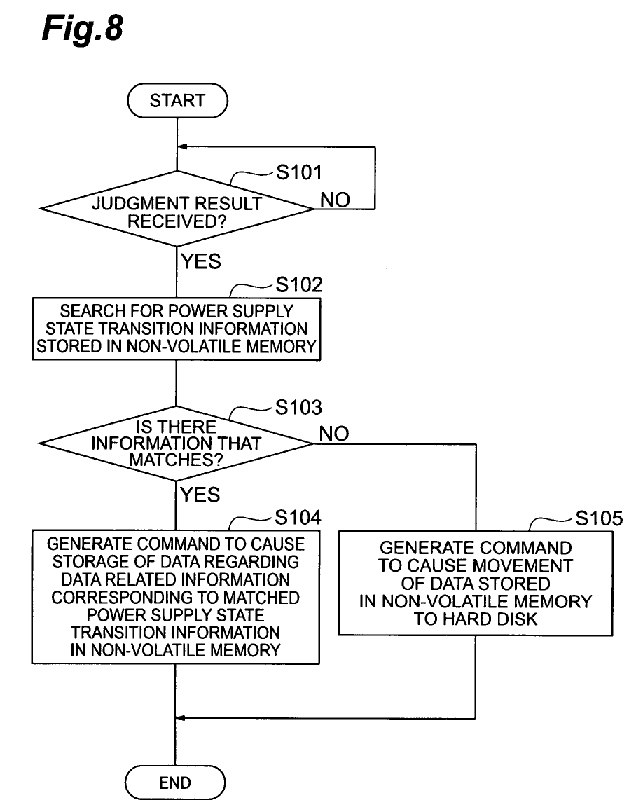

The command generating unit 703 generates various types of commands for sending to the HDD 116. Specifically, as shown in FIG. 8, the command generating unit 703 waits until receiving a judgment result from the power supply state detecting unit 702 (S101), and when it receives a judgment result indicating that there is a transition of power supply state, it proceeds to block 102. Subsequently, the command generating unit 703 searches for power supply state transition information stored in the non-volatile memory 201 with the transition of power supply state when the judgment is made by the power supply state detecting unit 702 being a key (S102). Subsequently, based on a search result in block 102, the command generating unit 703 judges whether or not there is a transition that matches the transition of power supply state judged by the power supply state detecting unit 702 among transitions of power supply state indicated by the power supply state transition information stored in the non-volatile memory 201 (S103).

When the command generating unit 703 judges in block 103 that there is a transition that matches, it generates a command (storage command) to cause storage of data regarding data related information corresponding to the matched power supply state transition information into the non-volatile memory 301 from the hard disk 302 (S104). This generated storage command is sent from the CPU 111 to the HDD 116 via for example the ATA controller provided in the south bridge 115. On the other hand, when the command generating unit 703 judges in block 103 that there is no transition that matches, it generates a command (move command) to cause movement of data (the startup time authorization data, the mail authorization data, the SMART data, and so on) stored in the non-volatile memory 301 to the hard disk 302 (S105). This generated move command is sent to the HDD 116 via for example the ATA controller provided in the south bridge 115. Here, examples of the case where there is no transition that matches in block 103 include a case that the power supply state changes from S4 or S5 to S0, a case that it changes to S0 due to a restart being executed, a case of changing from a power-saving mode to S0, and a case that the battery and the AC adapter are both connected.

Now, processing in the above-described command generating unit 703 will be explained specifically taking an example of the case where the power supply state detecting unit 702 judges that there is a transition “S0→S4” of power supply state. Since “S0→S4” exists in the power supply state transition information stored in the non-volatile memory 201, when the power supply state detecting unit 702 judges that there is a transition “S0→S4” of power supply state, the command generating unit 703 judges in block 103 that there is a match. Then, the command generating unit 703 generates a storage command to cause storage of data A1, A2, B1 (refer to FIG. 3) regarding the data related information “A1”, “A2”, “B1” corresponding to the power supply state transition information “S0→S4” into the non-volatile memory 301 from the hard disk 302, and sends the command from the CPU 111 to the HDD 116.

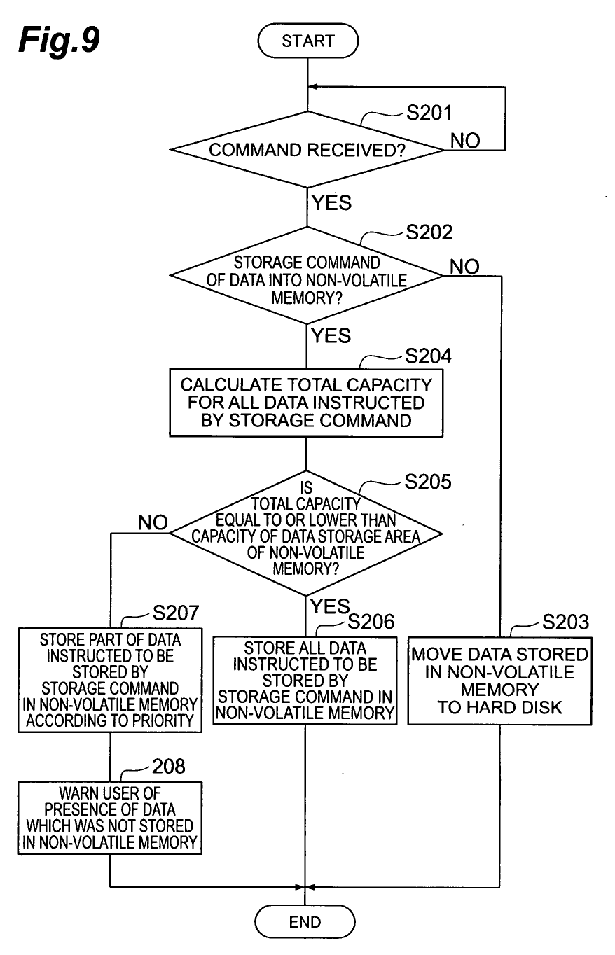

Next, a processing procedure in the HDD 116 when a command is received will be described with reference to the flowchart of FIG. 9.

The HDD 116 waits until it receives a command sent from the command generating unit 703 via the CPU 111 (S201). When the HDD 116 receives a command, it proceeds to block 202 to judge whether the received command is the storage command in block 104 or not (S202).

When the HDD 116 judges in block 202 that it is not the storage command (it is a move command), it proceeds to block 203 to move data (the startup time authorization data, the mail authorization data, the SMART data, and so on) stored in the non-volatile memory 301 to the hard disk 302 (S203), and finishes the processing. On the other hand, when the HDD 116 judges in block 202 that the command is the storage command, it proceeds to block 204 to calculate a total capacity by summing capacities for all the data instructed to be stored in the non-volatile memory 301 by the storage command (S204). Subsequently, the HDD 116 compares the total capacity calculated in block 204 with the capacity of the data storage area 402 in the non-volatile memory 301, and judges whether the total capacity is equal to or lower than the capacity of the data storage area 402 (S205).

When the HDD 116 judges in block 205 that the total capacity is equal to or lower than the capacity of the data storage area 402, it stores in the non-volatile memory 301 all the data instructed to be stored in the non-volatile memory 301 by the storage command (S206), and finishes the processing. On the other hand, when the HDD 116 judges in block 205 that the total capacity is larger than the capacity of the data storage area 402, it stores in the non-volatile memory 301 a part of the data instructed to be stored in the non-volatile memory 301 by the storage command according to the priority (S207). Specifically, the HDD 116 stores in the non-volatile memory 301 from data regarding data related information having the highest priority to data before one for which the total capacity, calculated by summing capacities for data regarding data related information in the order of descending priority, exceeds the capacity of the data storage area 402, among the data instructed to be stored in the non-volatile memory 301 by the storage command. Subsequently, the HDD 116 displays on the LCD 16 that a part of the data instructed to be stored in the non-volatile memory 301 by the storage command was not stored in the non-volatile memory 301 to notify the user (S208) of it, and finishes the processing.

Here, processing in the above-described HDD 116 will be described specifically taking an example of the case where the power supply state detecting unit 702 judges that there is a transition “S0→S4” of power supply state, and the HDD 116 receives a command to cause storage of data A1, A2, B1 regarding data related information “A1”, “A2”, “B1” (refer to FIG. 3) corresponding to the transition “S0→S4” of power supply state into the non-volatile memory 301 from the hard disk 302. In this case, in block 204, the HDD 116 calculates the total capacity by summing capacities for the data A1, A2, B1. Subsequently, the HDD 116 judges whether or not the total capacity for the data A1, A2, B1 is equal to or lower than the capacity of the data storage area 402 (S205), and stores all the data A1, A2, B1 in the non-volatile memory 301 when the total capacity for the data A1, A2, B1 is equal to or lower than the capacity of the data storage area 402 (S206).

On the other hand, when the HDD 116 judges that the total capacity for the data A1, A2, B1 is larger than the capacity of the data storage area 402, it compares the capacity for the data A1 having the highest priority with the capacity of the data storage area 402. When the HDD 116 judges that the capacity for the data A1 is equal to or lower than the capacity of the data storage area 402, it adds the capacity for the data A2 having the second highest priority next to the data A1 to the capacity for the data A1, and compares the total capacity for the data A1, A2 with the capacity of the data storage area 402. When the HDD 116 judges that the total capacity for the data A1, A2 is equal to or lower than the capacity of the data storage area 402, it stores the data A1, A2 in the non-volatile memory 301 (S206). Specifically, when the total capacity for the data A1, A2, B1 instructed to be stored in the non-volatile memory 301 by the storage command is larger than the capacity of the data storage area 402, the data A1, A2 as a part of the data A1, A2, B1 instructed to be stored in the non-volatile memory 301 by the storage command are stored in the non-volatile memory 301 according to the priority.

As above, in this embodiment, the non-volatile memory 201 stores the power supply state transition information and three pieces of the data related information in a correlated manner. Further, the command generating unit 703 searches for power supply state transition information stored in the non-volatile memory 201 with a transition of power supply state judged by the power supply state detecting unit 702 being a key. Then, as a result of this search, when the command generating unit 703 judges that there is a transition that matches, the command generating unit 703 generates a storage command to cause storage of data regarding the data related information corresponding to the matched power supply state transition information into the non-volatile memory 301 from the hard disk 302. When the HDD 116 receives this storage command, the data regarding the data related information corresponding to the aforementioned matched power supply state transition information is stored in the non-volatile memory 301 from the hard disk 302. Thus, it becomes possible to store necessary data in the non-volatile memory 301 according to a transition of power supply state. As a result, in addition to the effect obtained by using the non-volatile memory 301 that reduction of data processing time, reduction of power consumption, and reduction of influence of an external force such as vibration can be realized while reducing the risk of breaking the hard disk 302, the non-volatile memory 301 can be utilized quite effectively.

Further, in this embodiment, the non-volatile memory 201 stores the power supply state transition information and the three pieces of data related information in a correlated manner in a state that priority is assigned to the data related information. Accordingly, data regarding data related information are stored in the non-volatile memory 301 in the order of descending priority. As a result, the non-volatile memory 301 can be utilized more effectively.

Further, in this embodiment, if the total capacity for all the data instructed to be stored in the non-volatile memory 301 by the storage command is larger than the capacity of the data storage area 402, data regarding data related information are stored in the non-volatile memory 301 in the order of descending priority so that the capacity of the data storage area 402 is not exceeded. Thus, since data stored in the non-volatile memory 301 is selected automatically based on the priority and capacity, the non-volatile memory 301 can be utilized more effectively.

Further, in this embodiment, if the total capacity for all the data instructed to be stored in the non-volatile memory 301 by the storage command exceeds the capacity of the data storage area 402, it is displayed on the LCD 16 that a part of data is not stored in the non-volatile memory 301 to notify the user of it. Thus, the user can easily recognize the fact that the part of data is not stored in the non-volatile memory 301.

Further, in this embodiment, when the command generating unit 703 judges that there is no transition that matches as a result of search for power supply state transition information stored in the non-volatile memory 201, the HDD 116 receiving a move command moves data (the startup time authorization data, the mail authorization data, the SMART data, and so on) stored in the non-volatile memory 301 to the hard disk 302. Accordingly, in a situation that the startup time authorization data, the mail authorization data, the SMART data, and so on are not used, the non-volatile memory 301 can be used for another application, and thus the non-volatile memory 301 can be utilized more effectively. Further, since the number of rewriting on the non-volatile memory 301 is limited, switching of the medium in which the startup time authorization data, the mail authorization data, the SMART data, and so on are to be stored between the non-volatile memory 301 and the hard disk 302 in this manner can contribute to extension of the lifetime of the non-volatile memory 301.

Further, in this embodiment, data to be stored in the non-volatile memory 301 when there is a transition of power supply state include the startup time authorization data, the mail authorization data, the SMART data, and so on. Accordingly, when it is configured to store the startup time authorization data in the non-volatile memory 301 when the transition of power supply state is “S0→S4” for example, it becomes no longer necessary to read the startup time authorization data from the hard disk 302 at the time of startup of the computer 10, so that the startup of the computer 10 can be done quickly. Further, when it is configured to store the mail authorization data in the non-volatile memory when the transition of power supply state is “S0→S5” for example, it is not necessary to read the mail authorization data from the hard disk 302 in a case of carrying around the computer 10 and accessing a mail server regularly with a configuration to notify the user of reception of a mail by sound or the like, and thus it is possible to prevent a failure such as damaging the head of the hard disk 302 by vibration or the like during movement while sending/receiving mails. Further, when it is configured to store the SMART data in the non-volatile memory 301 when a transition of power supply state is “AC adapter→battery” for example, it is not necessary to spin up the hard disk 302 when reading the SMART data from the hard disk 302. Therefore, the power consumed for reading the SMART data can be reduced significantly as compared to the case of reading the SMART data from the hard disk 302, and thereby the driving time of the battery can be extended.

As above, the preferred embodiment of the present invention have been described, but the invention is not limited to the above-described embodiment. For example, in this embodiment, the power supply state transition information and the data related information are stored in the non-volatile memory 201 in a correlated manner according to the setting by the user, but it is also possible to prepare a plurality of setting modes assuming modes of actions by the user (for example, a “quick startup mode” in which the startup time authorization data is correlated to the power supply state transition information “S0→S4” and stored, a “mobile mode” in which the mail authorization data is correlated to the power supply state transition information “S0→S5” and stored, and so on), and then the user is allowed to select these modes. When these modes are selected by the user, the non-volatile memory 201 stores the power supply state transition information “S0→S4” and the startup time authorization data in a correlated manner in advance, and stores the power supply state transition information “S0→S5” and the mail authorization data in a correlated manner in advance for example.

Further, in this embodiment, the data related information to be stored in a correlated manner with the power supply state transition information in the non-volatile memory 201 are set to three pieces at the maximum, but there may be at least one piece of data related information to be stored in a correlated manner with the power supply state transition information. Further, besides the correlation of the power supply state transition information and the data related information, other conditions may be correlated further. By increasing the setting conditions in this manner, the computer 10 can be operated in any way the user desires.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data processing apparatus, comprising:
a disk drive having a non-volatile memory and a disk storage medium;
a setting unit for setting priority to each of a plurality of memory storage data to be stored in the non-volatile memory; and
a control unit for storing in the non-volatile memory at least one data among the plurality of memory storage data according to the priority set by said setting unit.

2. The data processing apparatus according to claim 1,
wherein said setting unit sets the priority according to an operation input information inputted by an operation device.

3. The data processing apparatus according to claim 1,
wherein said setting unit sets the priority to each of the plurality of memory storage data according to assumed modes of actions of a user.

4. The data processing apparatus according to claim 1,
wherein the plurality of memory storage data include at least one startup time authorization data as data to be used by a device which needs authorization during start up, and
wherein said setting unit sets priority of the startup time authorization data higher than that of other memory storage data so that the startup time authorization data is stored in the non-volatile memory with higher priority when there is a transition of a predetermined power supply state.

5. The data processing apparatus according to claim 1,
wherein the plurality of memory storage data includes at least one mail authorization data used for authorization when sending or receiving a mail, and
wherein said setting unit sets priority of the mail authorization data higher than that of other memory storage data so that the mail authorization data is stored in the non-volatile memory with higher priority when there is a transition of a predetermined power supply state.

6. The data processing apparatus according to claim 1,
wherein the plurality of memory storage data include at least one diagnosis data indicating a diagnosis result from execution of a self diagnosis function included in said disk drive, and
wherein said setting unit sets priority of the diagnosis data higher than that of other memory storage data so that the diagnosis data is stored in the non-volatile memory with higher priority when there is a transition of a predetermined power supply state.

7. The data processing apparatus according to claim 1,
wherein said setting unit sets the priority to each of the plurality of memory storage data in correlation with power supply state transition information indicating transitions of power supply state, and
wherein said control unit stores in the non-volatile memory at least one memory storage data among the plurality of memory storage data according to the priority when there is a transition of power supply state that matches the power supply state transition information.

8. The data processing apparatus according to claim 7,
wherein said control unit moves memory storage data stored in the non-volatile memory among the plurality of memory storage data to the disk storage medium when there is a transition of power supply state that does not match the power supply state transition information.

9. The data processing apparatus according to claim 1,
wherein said control unit stores at least one data among the plurality of memory storage data in the non-volatile memory in the order of descending priority according to a capacity of a storage area of the non-volatile memory.

10. The data processing apparatus according to claim 1,
wherein said control unit notifies a user when a total capacity for all of the plurality of memory storage data exceeds a capacity of a storage area of the non-volatile memory.
